(19) United States
(12) Patent Application Publication
(10) Pub. No.: US 2013/0174793 A1
(43) Pub. Date: Jul. 11, 2013

(54) APPARATUS FOR CLEANING AND DRYING ANIMAL PAWS TO PREVENT TRACKING MUD AND DIRT INSIDE

(71) Applicant: Jewell Renee Powell, LaPlata, MD (US)

(72) Inventor: Jewell Renee Powell, LaPlata, MD (US)

(21) Appl. No.: 13/737,881

(22) Filed: Jan. 9, 2013

Related U.S. Application Data
(60) Provisional application No. 61/584,704, filed on Jan. 9, 2012.

(51) Int. Cl. A01K 13/00

(52) U.S. Cl. CPC A01K 13/001
USPC 119/652

(57) ABSTRACT

A two-part self-cleaning system cleans and dries animal paws prior to when the animal enters a home. The system is an effective and hands-free way for the animal to clean and dry their paws so as not to track dirt, mud and other grime indoors and onto clean flooring. The system can include two parts—a sponge part for washing a pet's paws, and a drying pad for drying the pet's paws. A pet-friendly disinfectant can be included in the sponge portion to help disinfect the pet's paws before they walk about the home.

### CROSS-REFERENCE TO RELATED APPLICATION

This application claims the benefit of priority of U.S. provisional application No. 61/584,704, filed Jan. 9, 2012, the contents of which are herein incorporated by reference.

### BACKGROUND OF THE INVENTION

The present invention relates to animal paws cleaning devices and, more particularly, to an apparatus for cleaning and drying animal paws to prevent tracking mud and dirt inside.

Consumers are always trying to protect their floors and carpet from becoming overly saturated with dirt and grime. People often ask their guests to remove their shoes prior to entering or have them wipe their feet on a floor mat. Unfortunately, for pet owners, there is no way of having their beloved animals to wash or wipe their paws before entering the house.

People often resort to towels, floor mats and doggie boots to try to prevent their pets from frolicking in with muddy paws. However, the pets still somehow wreak havoc on floors and carpets.

Some conventional devices require pet owners to grab their pet's paws and wipe them or rinse them in water and dry them. This, however, requires a pet owner's intervention each time the pet comes inside, which often is not possible or practical.

Other conventional devices can clean or wipe paws, but they do not do both. In addition, many conventional devices do not disinfect the paws.

As can be seen, there is a need for an improved device that provides a pet owner with a quick, easy and hands-free means of cleaning and drying the paws of their pets when they enter the house, thereby maintaining a clean and healthy home environment.

### SUMMARY OF THE INVENTION

In one aspect of the present invention, a system for cleaning and drying animal paws comprises a first tray; an absorbent pad fitting into the first tray; a second tray; a dry pad fitting into the second tray; at least one hinge connecting the first tray to the second tray so that the first tray can fold together against the second tray in a closed configuration and so that the first tray can be open and lay flat next to the second tray in an opened configuration; and a closing mechanism to hold the first tray against the second tray in the closed configuration.

In another aspect of the present invention, a system for cleaning and drying animal paws comprises a first tray; an absorbent pad fitting into the first tray; a second tray; a dry pad fitting into the second tray; a moisture barrier operable to be disposed between the absorbent pad and the dry pad in the closed configuration; a plurality of anti-slip pads disposed on a bottom side of the first tray and the second tray; at least one hinge connecting the first tray to the second tray so that the first tray can fold together against the second tray in a closed configuration and so that the first tray can be open and lay flat next to the second tray in an opened configuration; and a closing mechanism to hold the first tray against the second tray in the closed configuration.

These and other features, aspects and advantages of the present invention will become better understood with reference to the following drawings, description and claims.

### BRIEF DESCRIPTION OF THE DRAWINGS

FIG. 1 is a forward perspective view of two-part self-cleaning system, in a closed configuration, according to an exemplary of the present invention;

FIG. 2 is a rear perspective view of the two-part self-cleaning system of FIG. 1;

FIG. 3 is a detailed rear perspective view of the two-part self-cleaning system of FIG. 1, illustrating a hinge member;

FIG. 4 is a top view of the two-part self-cleaning system of FIG. 1;

FIG. 5 is a side view of the two-part self-cleaning system of FIG. 1;

FIG. 6 is a perspective view of the two-part self-cleaning system of FIG. 1, in an open configuration;

FIG. 7 is a cross-sectional view taken along line 7-7 of FIG. 2;

FIG. 8 is a detailed perspective view illustrating an exemplary locking clasp and locking clasp slot for securing the two-part self-cleaning system of FIG. 1 in a closed configuration; and

FIG. 9 is a top view of a two-part self-cleaning system according to another embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a two-part self-cleaning system for cleaning and drying animal paws prior to entering a home.

The system is an effective and hands-free way for the animal to clean and dry their paws so as not to track dirt, mud and other grime indoors and onto clean flooring. The system can include two parts—a sponge part for washing a pet's paws, and a drying pad for drying the pet's paws. A pet-friendly disinfectant can be included in the sponge portion to help disinfect the pet's paws before they walk about the home.

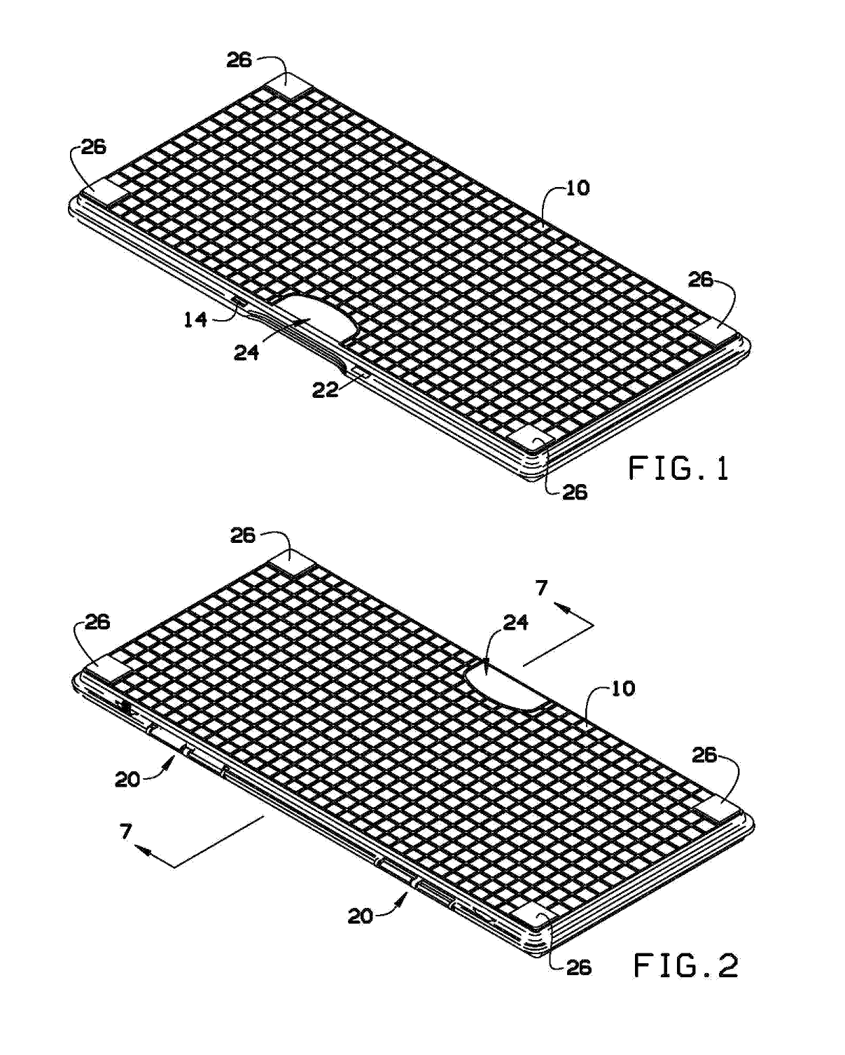

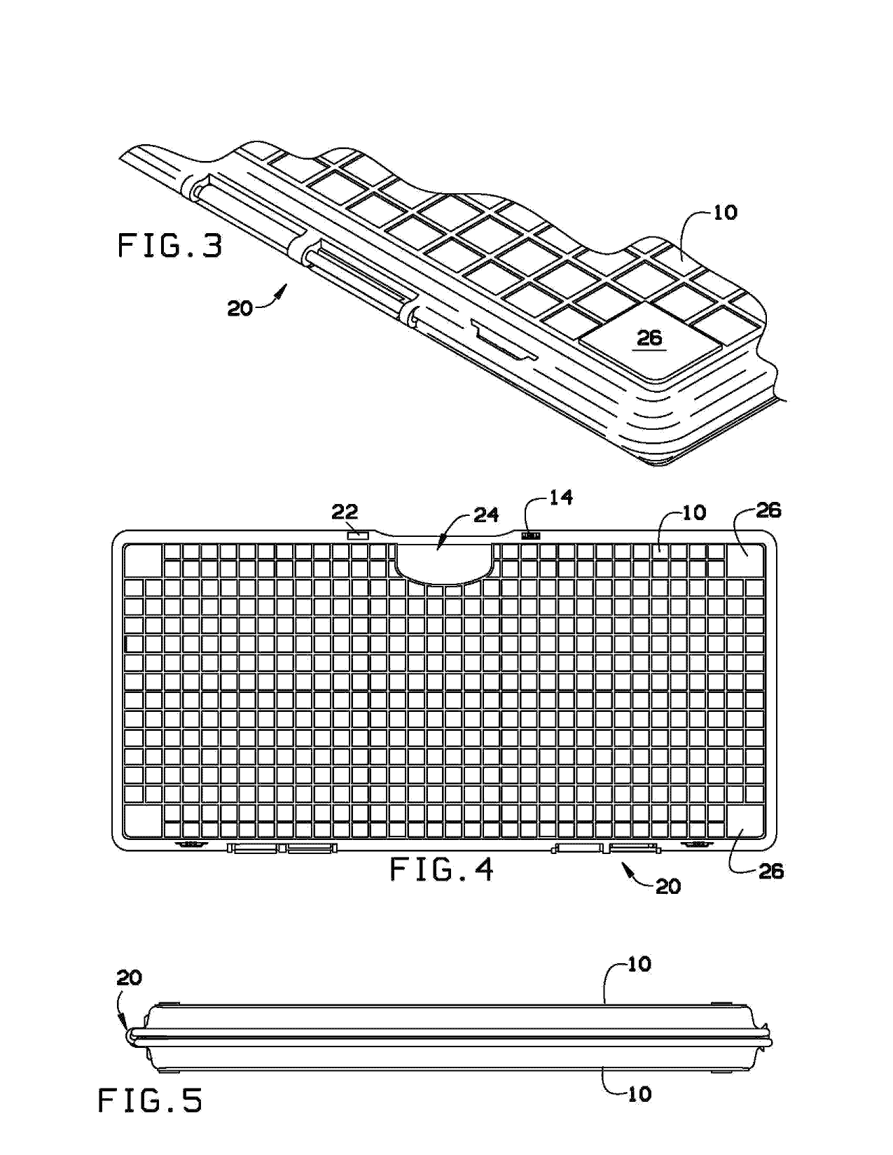

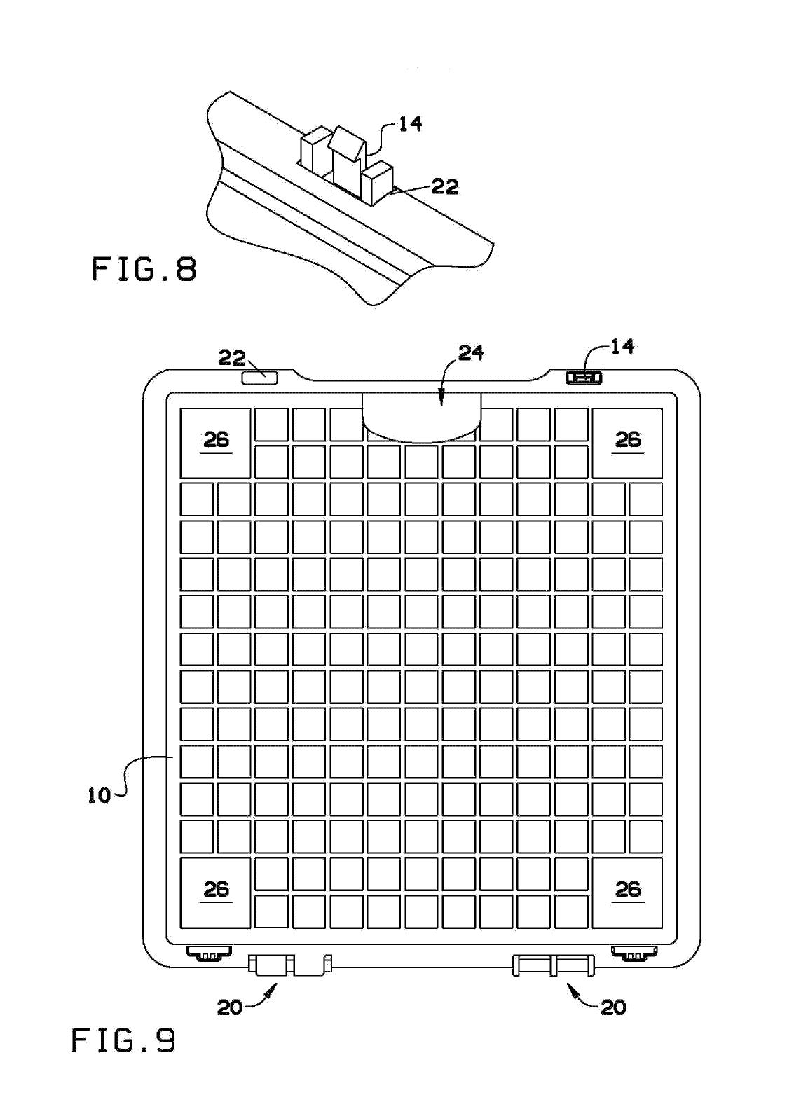

Referring now to FIGS. 1 through 8, a two-part self-cleaning system for cleaning and drying animal paws includes two tray panels 10 attached together with one or more hinges 20, typically two hinges 20, along one side thereof. The two tray panels 10 can fold together, about the hinges 20, to close upon one another. The hinges 20 can be formed in various manners, such as with a pin passing through hinge holes on each of the two tray panels 10. Other hinge styles are contemplated within the scope of the present invention, including living hinges, piano-type hinges, and the like.

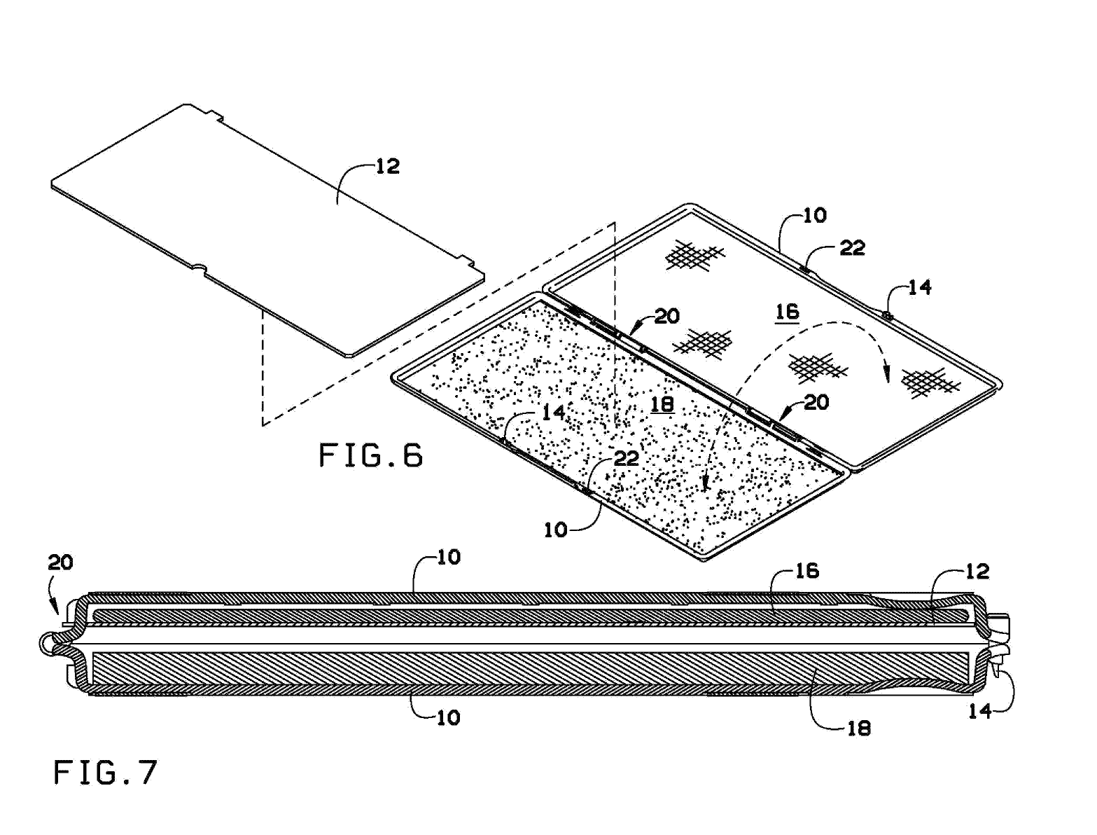

A clasp 14 can be disposed on a side opposite the hinges 20 to hold the two tray panels 10 in a closed configuration (as shown in FIGS. 1 through 5, for example). In some embodiments, two clasps 14 can be used. In some embodiments, one clasp 14 can extend from one of the two tray panels 10 and another clasp 14 can extend from the other one of the two tray panels 10, as shown in FIG. 6, for example. A clasp slot 22 can be disposed in the tray panel 10 not having the clasp 14 so that the clasp 14 can fit into the clasp slot 22 to hold the two tray panels 10 in a closed configuration. Other closures can be used within the scope of the present invention. For example, a sliding lock mechanism, a pivoting external clip, or the like, can be used to hold the two tray panels 10 in the closed configuration. In some embodiments, the closures can be disposed not only on the side opposite the hinged side, but closures could be disposed on the sides adjacent the hinge side, for example.

A handle region 24 can be formed from the two tray panels 10. The handle region 24 can be formed typically on a side opposite the hinged side of the two tray panels 10. In some embodiments, a handle region 24 can be formed other sides of the two tray panels, instead of or in addition to the handle region 24 on the side opposite the hinged side.

One of the two tray panels 10 can contain an absorbent pad 16, such as a sponge or the like, that can provide cleaning of a pet's paws as they walk over the absorbent pad 16. The absorbent pad 16 can contain water and/or a disinfectant for cleaning the paws of a pet.

The other one of the two tray panels 10 can contain a dry pad 18, such as a bath mat, door mat, carpet, or the like. The dry pad 18 can be designed to help dry a pet's paws as they walk over the dry pad 18.

Each of the two tray panels 10 can include anti-slip pads 26 formed on a bottom side thereof. While the Figures show four anti-slip pads 26 on each of the two tray panels 10, other number of anti-slip pads 26 can be used. In some embodiments, an entire bottom side of each of the two tray panels 10 can be coated with an anti-slip material. The anti-slip material can be any material that provides an increased friction with the floor as compared with the tray panels themselves. The anti-slip material could be rubber, silicone, coated fabrics, or the like.

To use the system of the present invention, a user can open the two tray panels 10 and lay them flat on the floor so that a pet entering from outside would walk on the absorbent pad 16 and then on the dry pad 18 before being allowed to roam about in the house.

The dry pad 18 and the absorbent pad 16 can be removed for cleaning, drying or replacement. If the user desires to close the two tray panels together, and the absorbent pad is damp, a moisture barrier 12 can be disposed between the absorbent pad 16 and the dry pad 18 to keep moisture from getting onto the dry pad 18 from the absorbent pad 16. The moisture barrier 12 can be formed from various materials, such as, for example, a coated paper or plastic.

As shown in FIG. 9, the system of the present invention can be designed in various sizes. Different sizes may be available depending on the space available to the user and/or the size of the pet. For example, smaller pets could use a smaller system and still walk along both of the pads 16, 18.

It should be understood, of course, that the foregoing relates to exemplary embodiments of the invention and that modifications may be made without departing from the spirit and scope of the invention as set forth in the following claims.

What is claimed is:

1. A system for cleaning and drying animal paws comprising:
a first tray;
an absorbent pad fitting into the first tray;
a second tray;
a dry pad fitting into the second tray;
at least one hinge connecting the first tray to the second tray so that the first tray can fold together against the second tray in a closed configuration and so that the first tray can be open and lay flat next to the second tray in an opened configuration; and
a closing mechanism to hold the first tray against the second tray in the closed configuration.

2. The system of claim 1, further comprising a moisture barrier operable to be disposed between the absorbent pad and the dry pad in the closed configuration.

3. The system of claim 1, wherein the closing mechanism is at least one clasp.

4. The system of claim 3, wherein the at least one clasp includes a first clasp and a second clasp disposed on a side opposite the at least one hinge.

5. The system of claim 1, wherein the at least one hinge includes a first hinge and a second hinge disposed along one side of the first tray and the second tray.

6. The system of claim 1, further comprising a plurality of anti-slip pads disposed on a bottom side of the first tray and the second tray.

7. The system of claim 1, further comprising a handle region formed from in the first tray and the second tray, the handle region operable to assist a user to carry the system in the closed configuration.

8. A system for cleaning and drying animal paws comprising:
a first tray;
an absorbent pad fitting into the first tray;
a second tray;
a dry pad fitting into the second tray;
a moisture barrier operable to be disposed between the absorbent pad and the dry pad in the closed configuration;
a plurality of anti-slip pads disposed on a bottom side of the first tray and the second tray;
at least one hinge connecting the first tray to the second tray so that the first tray can fold together against the second tray in a closed configuration and so that the first tray can be open and lay flat next to the second tray in an opened configuration; and
a closing mechanism to hold the first tray against the second tray in the closed configuration.

9. The system of claim 8, further comprising a handle region formed from in the first tray and the second tray, the handle region operable to assist a user to carry the system in the closed configuration.

10. The system of claim 8, wherein the closing mechanism is at least one clasp.

11. The system of claim 10, wherein the at least one clasp includes a first clasp and a second clasp disposed on a side opposite the at least one hinge.

12. The system of claim 8, wherein the at least one hinge includes a first hinge and a second hinge disposed along one side of the first tray and the second tray.
